(19) United States
(12) Patent Application Publication
(10) Pub. No.: US 2009/0055683 A1
(43) Pub. Date: Feb. 26, 2009

(54) Method of restoring previous computer configuration

(76) Inventors: Ronald Wells, Arnold, MO (US); Michael Goyins, Catawissa, MO (US)

Correspondence Address: SPENCER, FANE, BRITT & BROWNE, 1000 WALNUT STREET, SUITE 1400, KANSAS CITY, MO, 64106-2140, US

(21) Appl. No.: 11/895,337

(22) Filed: Aug. 24, 2007

(51) Int. Cl. G06F 11/00

(52) U.S. Cl. 714/15; 714/E11.001

(57) ABSTRACT

A method of handling and storing data in a computer by establishing a plurality of zones or sessions with different levels of write protection, writing attempted changes to data stored in a protected zone to a temporary zone, creating representative maps of some or all of the zones or sessions to track such attempted changes, reading the changes from the temporary zone such that it seems as though the changes were successful, and erasing the temporary zone when the computer is restarted, thereby allowing for “restoring” the data, or, more generally, the computer's configuration, to a state prior to the attempted change. One of the zones may contain working files which are relatively frequently changed, and such changes are treated, e.g., saved, in a substantially conventional manner and not affected by restarting the computer. Access to specific non-temporary zones may be restricted.

### FIELD OF THE INVENTION

The present invention relates to methods of handling and storing data in a computer. More specifically, the present invention concerns a method of handling and storing data in a computer by establishing a plurality of zones or sessions with different levels of write protection, writing attempted changes to data stored in a protected zone to a temporary zone, creating representative bitmaps of some or all of the zones or sessions to track such attempted changes, reading the changes from the temporary zone such that it seems as though the changes were successful, and erasing the temporary zone when the computer is restarted, thereby allow for “restoring” the data, or, more generally, the computer's configuration, to a state prior to the attempted change.

### BACKGROUND OF THE INVENTION

It is generally desirable to prevent unauthorized or otherwise unwanted changes to certain data in a computer, especially changes to data which governs operation of the computer. Such changes may result from malware, such as viruses, spyware, key loggers, worms, adware, and Trojan horses, which may be unknowingly downloaded via a network connection or from an infected portable data storage device, or such changes may be knowingly or unknowingly implemented by a user of the computer.

One solution has been to employ software designed to identify and block, counteract, or remove such malware. Unfortunately, these programs work with varying degrees of success and are always at risk of being circumvented by the ever-adapting malware. Another solution has been to impose security features which require proof of authorization or approval, e.g., passwords or physical keys, in order to make changes. Unfortunately, these features can be similarly problematic and, furthermore, can be burdensome to the computer user.

### SUMMARY OF THE INVENTION

The present invention address the above-identified and other problems and disadvantages in prior systems by providing a method of handling and storing data in a computer by establishing a plurality of zones or sessions with different levels of write protection, writing attempted changes to data stored in a protected zone to a temporary zone, creating representative bitmaps of some or all of the zones or sessions to track such attempted changes, reading the changes from the temporary zone such that it seems as though the changes were successful, and erasing the temporary zone when the computer is restarted, thereby allowing for “restoring” the data, or, more generally, the computer's configuration, to a state prior to the attempted change. With the protection provided by the present invention, a computer user can safely connect to a network such as the Internet; download files; expose the computer to malware such as viruses, spyware, key loggers, worms, adware, and Trojan horses; experiment with different system settings; and otherwise expose the computer's configuration to change without fear of permanent damage.

In one embodiment, the method comprises the steps of establishing a first data storage zone for data of a first type; establishing a second data storage zone for data of a second type; establishing a third data storage zone for data of a third type; treating as data of the second type an attempted change to data of the first type by writing the attempted change to and reading the attempted change from the second data storage zone; erasing data of the second type when the computer is restarted; and allowing a change to data of the third type and not erasing the change when the computer is restarted.

The method may further include any one or more of the following additional steps. The user is allowed to designate particular data as being data of the first type or data of the second type. The user is allowed to write a change directly to the first data storage zone. The change written directly to the first data storage zone is identified, and the identified change is reversed substantially automatically when requested to do so by the user. The second data storage zone has a size, and the user is allowed to increase or decrease the size of the second zone and/or the size of the second zone is increased or decreased substantially automatically based upon an amount of data of the second type. A map is created associating data of the second type with corresponding data of the first type. The map is initialized when the computer is restarted; when an attempt is made to write to data of the first type, the map is updated to associate resulting data of the second type with corresponding data of the first type; and when an attempt is made to read data of the first type, the map is used to identify corresponding data of the second type, and returning the identified data of the second type. The user is allowed to accept data of the second type by moving it to the first data storage zone. The user is allowed to store data of the second type in the first data storage zone; corresponding data of the first type is stored in the second data storage zone; and the user is allowed to reject the data of the second type by restoring the corresponding data of the first type to the first data storage zone.

In another embodiment, the method comprises the steps of establishing a first session data storage zone for a first set of data; establishing a second session data storage zone for a second set of data; including in the second set of data an attempted change to the first set of data by writing the attempted change to and reading the attempted change from the second session data storage zone; creating a map associating the second set of data with the first set of data; allowing a user to reject the second set of data by substantially automatically initializing the map when the computer is restarted; and allowing the user to accept the second set of data, and, in response thereto, treating the second set of data stored in the second session data storage zone in the same manner as the first set of data stored in the first session data storage zone, including not erasing the second set of data when the computer is restarted.

The method may further include any one or more of the following additional steps. A subsequent session data storage zone is established for a subsequent set of data; an attempted change to a previous session data storage zone is included in the subsequent set of data by writing the attempted change to and reading the attempted change from the subsequent session data storage zone; a map is created associating the subsequent set of data with the previous set of data; a user is allowed to reject the subsequent set of data by substantially automatically initializing the map when the computer is restarted; and the user is allowed to accept the subsequent set of data, and in response thereto, the subsequent set of data stored in the subsequent session data storage zone is treated in the same manner as the previous set of data stored in the previous session data storage zone, including not erasing the subsequent set of data when the computer is restarted. The user is allowed to revert to an earlier set of data by initializing the map associating earlier set of data with a corresponding subsequent set of data. An identifier is received from the user; the user is allowed to access one or more of the first, second, or subsequent sets of data based upon the identifier; and any of the first, second, or subsequent sets of data which are not accessible to the user are hidden from the user.

These and other important features of the present invention are described in greater detail below in the section titled DETAILED DESCRIPTION.

### BRIEF DESCRIPTION OF THE DRAWING FIGURES

The present invention is described herein with reference to the following drawing figures, with greater emphasis being placed on clarity rather than scale:

FIG. 1 is a depiction of a plurality of data storage zones and an associated representative bitmap created by an embodiment of the method of the present invention;

FIG. 2 is a flowchart of steps involved in practicing the embodiment of the method associated with FIG. 1;

FIG. 3 is a depiction of a plurality of sessions and associated representative bitmaps created by another embodiment of the present invention; and

FIG. 4 is a flowchart of steps involved in practicing the embodiment of the method associated with FIG. 4.

### DETAILED DESCRIPTION

With reference to the drawings figures, a method is herein described, shown, and otherwise disclosed in accordance with various embodiments, including a preferred embodiment, of the present invention.

Broadly characterized, the present invention concerns a method of handling and storing data in a computer by establishing a plurality of zones or sessions with different levels of write protection, writing attempted changes to data stored in a protected zone to a temporary zone, creating representative bitmaps of some or all of the zones or sessions to track such attempted changes, reading the changes from the temporary zone such that it seems as though the changes were successful, and erasing the temporary zone when the computer is restarted, thereby allowing for “restoring” the data, or, more generally, the computer's configuration, to a state prior to the attempted change. With the protection provided by the present invention, a computer user can safely connect to a network such as the Internet; download files; expose the computer to malware such as viruses, spyware, key loggers, worms, adware, and Trojan horses; experiment with different system settings; and otherwise expose the computer's configuration to change without fear of permanent damage.

As used herein, the word “change” broadly means a change to, addition to, or deletion from existing data. For example, the word “change” broadly encompasses changing the contents of a file, adding a new file, and deleting an existing file.

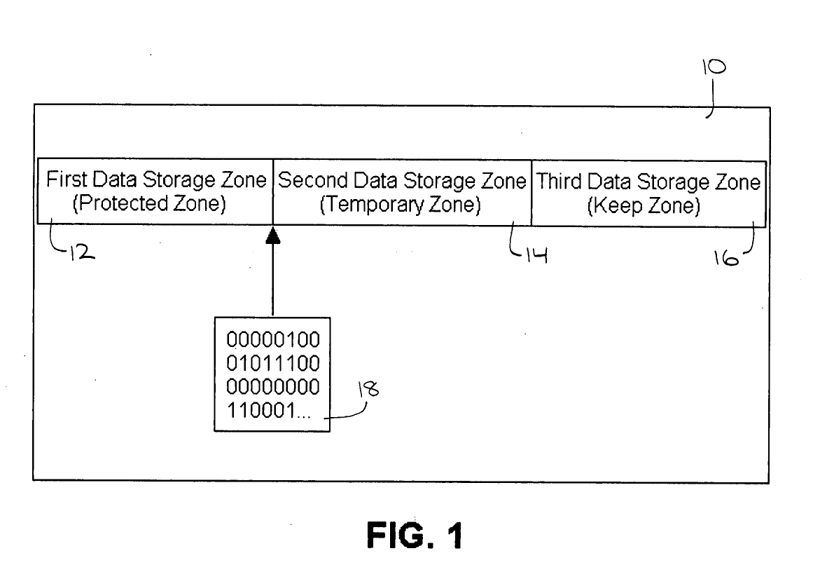

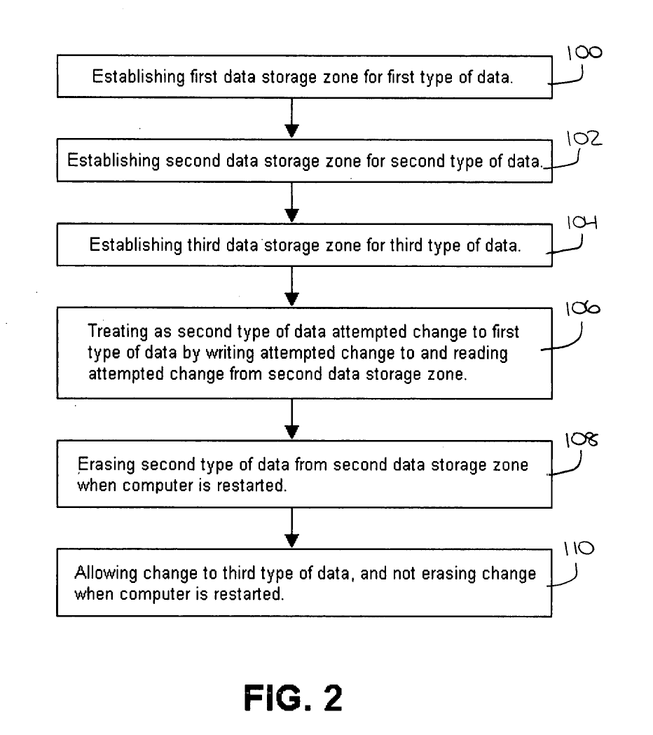

Referring to FIGS. 1 and 2, in one embodiment, the method of handling and storing data in a computer broadly comprises the following steps. A plurality of data storage zones are established on the computer's hard drive 10, with each zone having its own level of write protection, including a first data storage zone, i.e., a “Protected Zone” 12, for data of a first type, as shown in box 100; a second data storage zone, i.e., a “Temporary Zone” 14, for data of a second type, as shown in box 102; and one or more third data storage zones, i.e., “Keep Zones” 16, for data of a third type, as shown in box 104. When an attempt is made to change data of the first type stored in the Protected Zone 12, the attempted change is written to and read from the Temporary Zone 14 as data of the second type, i.e., “change data”, as shown in box 106. When the computer is restarted, the change data stored in the Temporary Zone 14 is erased, as shown in box 108. Data of the third type stored in the Keep Zone 16 is data that is changed relatively frequently; reads and writes to data stored in the Keep Zone are performed in a substantially conventional manner, and changes to it are not affected by restarting the computer, as shown in box 110.

As mentioned, change data is read from the Temporary Zone 14 until erased. More specifically, while the change data is present in the Temporary Zone, the computer behaves as though the attempted change to the original, protected data was successful. Whenever a call is made to read the original data from the Protected Zone, the change data is read from the temporary zone, and the change data is then used by whatever operation made the call. As discussed below in greater detail, this process is facilitated by associating specific change data stored in the Temporary Zone 14 with the corresponding original data stored in the Protected Zone 12 using, e.g., representative maps 18.

This embodiment of the method may be implemented as follows. When a computer is first turned on, a series of operations occurs to prepare the computer for use. One of the first operations is a “power on self test”, or POST, which involves identifying hardware associated with or connected to the computer. The POST is followed by the boot, which involves loading a portion of the kernel which includes the “hardware abstraction layer”, or HAL. The HAL involves abstracting specific hardware in order to make it appear generic with respect to, and therefore easier to use by, the user.

The present invention includes a driver, loaded during the HAL, which functions as an upper filter on the computer's hard drive. The driver uses the “master file table”, or MFT, to find the temporary storage file, and, based thereon, builds a representative bitmap of the hard drive. When the computer is restarted, the representative bitmap is initialized. An initial call to read data stored in the Protected Zone 12 results in the data being read directly and exclusively from the Protected Zone 12. When a call is made to write to, i.e., change, the data stored in the Protected Zone 12, the change is actually written to the Temporary Zone 14, and the representative bitmap is updated to reflect this occurrence and establish the association between the original data stored in the Protected Zone 12 and the change data stored in the Temporary Zone 14. When a call is made to read data stored in the Protected Zone 12, the representative bitmap directs the read to the change data stored in the Temporary Zone 14, thereby making it seem as though the change to the original data was successful. When the computer is restarted again, the change data stored in the Temporary Zone 14 is erased, the bitmap is re-initialized, and an initial call to read data stored in the Protected Zone 12 results in the original, unchanged data being read directly and exclusively from the Protected Zone 12, thereby effectively “restoring” the original data.

In another implementation, some or all of the change data stored in the Temporary Zone is ignored rather than erased when the computer is restarted.

Thus, the Protected Zone 12 is analogous to a vault in which important data is stored and protected from malicious, accidental, or otherwise undesired change. This data may include, for example, system settings, non-active or non-changing files, installed software, and any other data which the user may desire to protect. Whenever the user desires to add new data to the Protected Zone 12, or to change data already located there, the protection provided by the present invention must be either circumvented or temporarily disabled, such as by use of personal identification information such as a password, biometric, or physical mechanism, in order to make the change.

The present invention may also protect all non-file system areas, such as partition maps, on any disk drive that contains protected partitions, and furthermore, will refuse to perform a low-level format on any disk that contains protected volumes.

The Temporary Zone 14 is analogous to a chalkboard on which change data is written to and read from but which is erased substantially automatically whenever the computer is restarted. This data may include data downloaded, knowingly or unknowingly, by the user, unimportant or unknown files, dangerous malware, and willful or accidental attempts by the user to change data stored in the Protected Zone 12.

If the Temporary Zone 14 becomes full, an error message is communicated to the user indicating that the computer must be restarted in order to empty, or at least free some space within, the Temporary Zone 14. The user may be allowed to manually set the size of the Temporary Zone 14; additionally or alternatively, the present invention may substantially automatically resize the Temporary Zone 14 as needed.

The Keep Zone 16 contains data which is changed, e.g., updated, edited, altered, added, or deleted, relatively frequently. This data may include temporarily installed software, e.g., trial software; active or changing files such as images, movies, music, e-mail, electronic documents such as text or spreadsheet documents; and many user settings. As mentioned, reads and writes to this data are performed normally, and changes to this data are not affected by restarting the computer. Thus, unlike data stored in the Protected Zone 12, data stored in the Keep Zone 16 is not write-protected against change, and unlike data stored in the Temporary Zone 14, data stored in the Keep Zone 16 is not erased during restart.

It will be appreciated that any number of each type of data storage zone may be established. Furthermore, zones of the same type may have different levels of write protection. For example, a High-Level Protected Zone may be established which can only be changed by a particular user with high-level access rights, while a Medium-Level Protected Zone may be established which can be changed by one or more users with medium-level access rights.

As mentioned, data stored in the Protected Zone 12 can be changed. The present invention may further include an additional restoration feature operable to reverse such changes. In one embodiment, with protection enabled, change data is written to the temporary zone 14 along with tracking information associating the change data with the corresponding original data stored in the protected zone. As desired, and with appropriate safeguards, e.g., requiring entry of a password, the user can accept, or commit, the change data by moving it to the protected zone 12. In another embodiment, with protection disabled, change data is written directly to the protected zone 12, and the original data, along with tracking information associating the original data with the change data stored in the protected zone 12, is stored to the temporary zone 14. As desired, the user can accept the change data by restarting the computer and thereby erasing the original data stored in the temporary zone 14, or can restore the original data by using the tracking information to replace the change data with the original data in the protected zone. Thus, unwanted changes can be reversed whether operating in the protected mode or the unprotected mode.

By way of example and not limitation, the above-described embodiment of the present invention may operate and be used substantially as follows. In this example, the above-described method is implemented by a computer program stored on a computer-readable memory and executed by a computer. First, the user verifies the computer's configuration. Although the configuration, including data in the Protected Zone 12, can be changed after installation of the computer program and enablement of the protection it provides, it is may be easiest to begin with the desired configuration. Thus, prior to installing the computer program, all malware should be removed, all system settings should be set as desired, the computer's hard drive should be defragmented, and, generally, the computer's configuration should be checked and changed as desired.

Next, the user installs the computer program, thereby creating the various data storage zones. The time required to install the computer program may depend on such considerations as, for example, the amount of information being located in the Protected and Keep Zones.

Next, the user creates a password, entry of which will be necessary to enable, disable, and make certain changes to the operation of the computer program.

Next, the user reboots the computer for the first time since installation of the computer program, and enables the protection provided thereby. Once the computer completes its first reboot since installation of the computer program, the computer program is initially disabled, as indicated by a red Disabled Icon located in the system tray or other onscreen toolbar. Selecting this icon opens an interface which allows the user to, among other things, enable the protection as well as make certain changes to the operation of the computer program. When the protection is enabled, a green Enabled Icon replaces the red Disabled Icon in the system tray. Thereafter, whenever the user logs onto the computer, a pop-up window appears and provides the user with an alterative way to enable the protection or continue in the disabled mode. Whenever the user changes between enabled and disabled modes, the computer reboots to implement the change, and the new mode is in effect following this reboot.

Thereafter, the computer program operates as described above to substantially automatically handle and store data in the various Zones 112, 114, 116.

At any time, the user can set the size of the Temporary Zone 114. This is accomplished by double-selecting the displayed Icon to cause an interface window to appear, in which, among other things, the size can be changed by, for example, entering a numerical value or by manipulating a virtual mechanism, e.g., a virtual sliding bar. In one embodiment, the size can only be changed while protection is disabled.

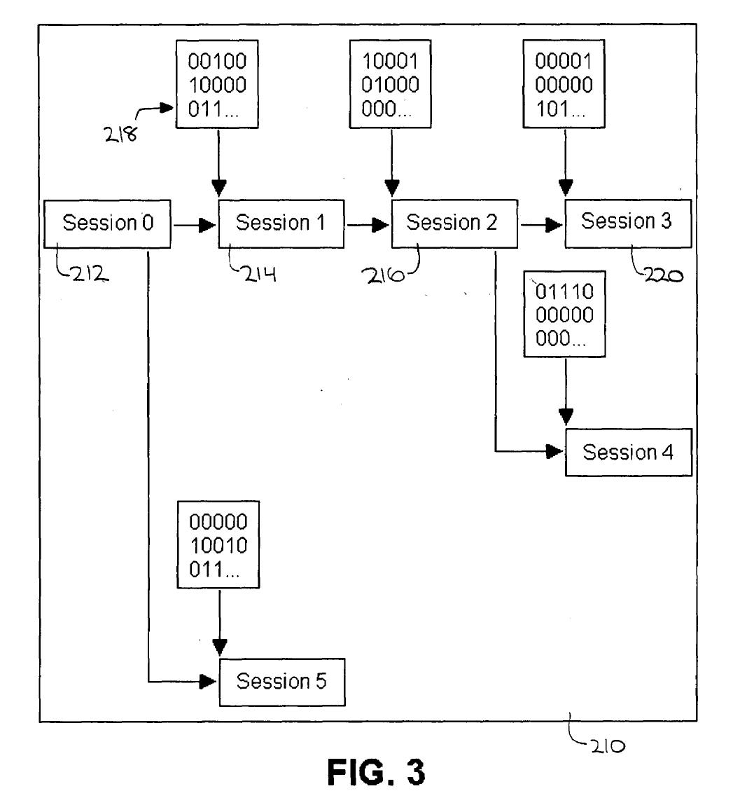

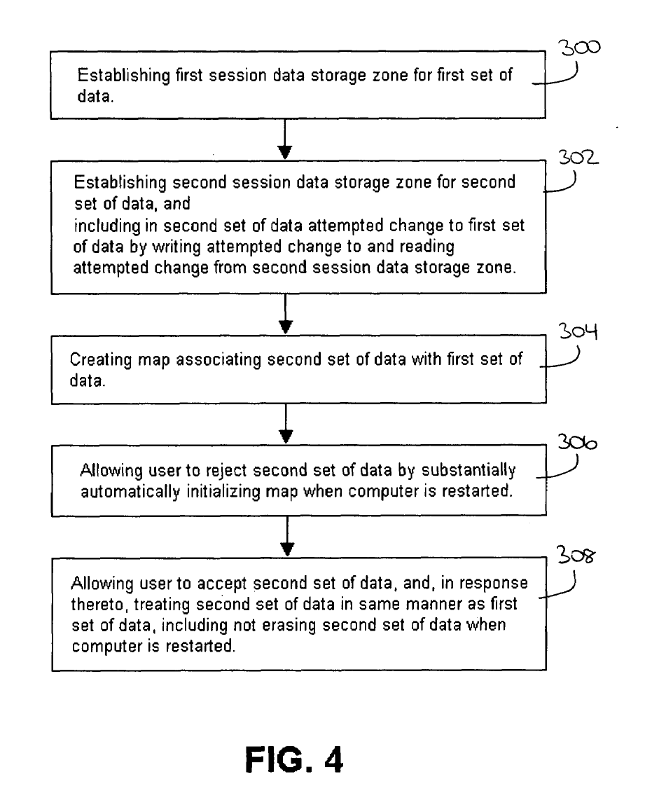

Referring to FIGS. 3 and 4, another embodiment of the method of handling and storing data may be substantially similar to the other embodiments except at least as follows. When the present invention is first enabled, substantially all data then stored on the hard drive 210 is stored in a first data storage zone which is designated Session Zero 212 and write-protected, as shown in box 300. More specifically, this original data is stored in a zone which is similar to the Protected Zone of the earlier embodiment.

An attempted change to the original data is stored in a second data storage zone which is designated Session One 214, as shown in box 302. A representative bitmap 218 is created associating the change data stored in Session One with the original data stored in Session Zero, as shown in box 304. The change data is, by default, treated substantially the same as the change data of the earlier embodiment, i.e., Session One 214 is treated similar to the Temporary Zone and substantially automatically erased when the computer is restarted, as shown in box 306. However, in the current embodiment, the change data can be accepted, or committed, in which case Session One 214 becomes a second write-protected zone similar to Session Zero 212, as shown in box 308. To be clear: in the earlier embodiment accepting change data results in a direct change in the original data stored in the Protected Zone, while in the current embodiment accepting change data results in no such direct change but rather results in Session One 214, i.e., the Temporary Zone, becoming a second Protected Zone and not subject to automatic erasure when the computer is restarted.

A subsequent change to the original data of Session Zero 212, or a change to the data of Session One 214, is stored in a data storage zone designated Session Two, which can be erased or accepted in the same manner as the data of Session One 214 was. A separate representative map 218 is created for each such session, with each such map referring to any and all previous maps associated with changes to the same data. For example, the relationships among the sessions shown in FIG. 3 are set forth in Table 1:

TABLE 1

| | |
|---|---|
| Session Zero | — |
| Session One | Map refers to Session Zero. |
| Session Two | Map refers to Session One; map of Session One refers to |
| | Session Zero. |
| Session Three | Map refers to Session Two; map of Session Two refers to |
| | Session One; map of Session One refers to Session Zero. |
| Session Four | Map refers to Session Two; map of Session Two refers to |
| | Session One; map of Session One refers to Session Zero. |
| Session Five | Map refers to Session Zero. |

In one embodiment, when the computer is restarted, the data of Session Zero 212 is read and the user is asked to enter an identifier, e.g., a password. Based upon the identifier, the computer identifies the particular sessions which the user is allowed to access. All other sessions are hidden from and inaccessible to the user. In one embodiment, changes made by the user to any accessible sessions are treated as a separate session and treated similar to the first, second, or third types of data of the earlier embodiment, i.e., the change data can be saved and write-protected as though stored in a Protected Zone, erased at restart as though stored in a Temporary Zone, or saved but not write-protected and not erased as though stored in a Keep Zone.

In one example, the computer is used in education. Session One corresponds to a basic mathematics lesson, Math 1; Session 2 corresponds to an advanced mathematics lesson, Math 2; Session 3 corresponds to a particular student, Student 1; Session 4 corresponds to another particular student, Student 2; and Session five corresponds to a basic physics lesson, Physics 1. Student 1 can access both Math 1 and Math 2, but can neither access nor see Student 2 and Physics 1. Similarly, Student 2 can access both Math 1 and Math 2, but can neither access nor see Student 1 and Physics 1.

In another example, the computer is used in business. Session One corresponds to a first business deal, Deal 1; Session 2 corresponds to a second business deal, Deal 2, which is related to the first business deal; Session 3 corresponds to a particular salesman, Seller 1; Session 4 corresponds to another particular salesman, Seller 2; and Session five corresponds to a third business deal, Deal 3, which is unrelated to the first or second business deals. Seller 1 can access both Deal 1 and Deal 2, but can neither access nor see Seller 2 and Deal 3. Similarly, Seller 2 can access both Deal 1 and Deal 2, but can neither access nor see Seller 1 and Deal 3.

It will be appreciated that the user, e.g., Student and Seller, sessions are isolated from one another. If Student 1 or Seller 1 were to become infected with a virus, the infection would not affect Student 2 or Seller 2, respectively, because the former effectively do not exist for the latter.

This embodiment also includes a restoration feature operable to reverse changes to data. One way to reverse changes made during the current session is to not accept them, i.e., to leave them as though stored in a Temporary Zone such that they are erased during restart. More generally, because each session is associated with its own representative bitmap which links the data of the previous session to the changes made in the subsequent session, it is possible to revert to any previous session by reinitializing the bitmaps of all subsequent sessions, thereby effectively erasing the change data associated with those subsequent sessions and “restoring” the desired data.

From the preceding discussion, it will be appreciated by one with ordinary skill in the art that the present invention provides significant advantages over the prior art, including, for example, allowing for “restoring” data, or, more generally, the computer's configuration, to a state prior to an attempted change of the data. Thus, a user of the computer can safely expose the computer's configuration to changes without fear of permanent damage.

Although the invention has been disclosed with reference to various particular embodiments, it is understood that equivalents may be employed and substitutions made herein without departing from the scope of the invention as recited in the claims.

Having thus described the preferred embodiment of the invention, what is claimed as new and desired to be protected by Letters Patent includes the following:

1. A method of handling and storing data in a computer, the method comprising the steps of:
establishing a first data storage zone for data of a first type;
establishing a second data storage zone for data of a second type;
establishing a third data storage zone for data of a third type;
treating as data of the second type an attempted change to data of the first type by writing the attempted change to and reading the attempted change from the second data storage zone;
erasing data of the second type when the computer is restarted; and
allowing a change to data of the third type and not erasing the change when the computer is restarted.

2. The method as set forth in claim 1, further comprising the step of allowing a user to designate particular data as being data of the first type or data of the second type.

3. The method as set forth in claim 1, further comprising the step of allowing a user to write a change directly to the first data storage zone.

4. The method as set forth in claim 3, further comprising the steps of
identifying the change written directly to the first data storage zone; and
reversing the identified change substantially automatically when requested to do so by the user.

5. The method as set forth in claim 1, wherein the second data storage zone has a size, and the method further comprises the step of allowing a user of the computer to change the size of the second zone.

6. The method as set forth in claim 1, wherein the second data storage zone has a size, and the method further comprises the step of substantially automatically changing the size of the second zone based upon an amount of data of the second type.

7. The method as set forth in claim 1, further comprising the step of creating a map associating data of the second type with corresponding data of the first type.

8. The method as set forth in claim 7, further including the steps of
initializing the map when the computer is restarted;
when an attempt is made to write to data of the first type, updating the map to associate resulting data of the second type with corresponding data of the first type; and
when an attempt is made to read data of the first type, using the map to identify corresponding data of the second type, and returning the identified data of the second type.

9. The method as set forth in claim 1, further comprising the step of allowing the user to accept data of the second type by moving it to the first data storage zone.

10. The method as set forth in claim 1, further comprising the steps of
allowing the user to store data of the second type in the first data storage zone;
storing corresponding data of the first type in the second data storage zone; and
allowing the user to reject the data of the second type by restoring the corresponding data of the first type to the first data storage zone.

11. A method of storing and handling data in a computer, the method comprising the steps of:
establishing a first data storage zone within which data is write protected;
establishing a second data storage zone within which data is not write protected and is erased when the computer is restarted;
establishing a third data storage zone within which data is not write protected and is retained when the computer is restarted; and
writing to the second storage zone an attempted change to data in the first data storage zone.

12. A method of handling and storing data in a computer, the method comprising the steps of:
establishing a first data storage zone for data of a first type;
establishing a second data storage zone for data of a second type;
treating as data of the second type an attempted change to data of the first type by writing the attempted change to and reading the attempted change from the second data storage zone;
erasing data of the second type when the computer is restarted; and
changing the size of the second zone substantially automatically based upon an amount of data of the second type.

13. A method of handling and storing data in a computer, the method comprising the steps of:
establishing a first data storage zone for data of a first type;
establishing a second data storage zone for data of a second type;
treating as data of the second type an attempted change to data of the first type by writing the attempted change to and reading the attempted change from the second data storage zone;
erasing data of the second type when the computer is restarted;
allowing a user to store data of the second type in the first data storage zone;
storing corresponding data of the first type in the second data storage zone; and
allowing the user to reject the data of the second type by restoring the corresponding data of the first type to the first data storage zone.

14. (canceled)

15. A method of handling and storing data in a computer, the method comprising the steps of:
establishing a first data storage zone for protected data;
establishing a second data storage zone;
establishing a third data storage zone;
writing to the second data storage zone an attempted change to the protected data;
reading from the second data storage zone the attempted change to the protected data when requested to read the protected data;
emptying the second data storage zone when the computer is restarted; and
allowing a change to data in the third data storage zone and not erasing the change when the computer is restarted.

16. The method as set forth in claim 15, further comprising the steps of
creating a map operable to associate the attempted change stored in the second data storage zone with the corresponding protected data stored in the first data storage zone;
initializing the map when the computer is restarted;
when an attempt is made to write the attempted change to the protected data, updating the map to associate the attempted change with the corresponding protected data; and
when an attempt is made to read the protected data, using the map to identify the corresponding attempted change, and returning the identified corresponding attempted change.

17. A method of handling and storing data in a computer, the method comprising the steps of:
establishing a first session data storage zone for a first set of data;
establishing a second session data storage zone for a second set of data;
including in the second set of data an attempted change to the first set of data by writing the attempted change to and reading the attempted change from the second session data storage zone;
creating a map associating the second set of data with the first set of data;
allowing a user to reject the second set of data by substantially automatically initializing the map when the computer is restarted; and
allowing the user to accept the second set of data, and, in response thereto, treating the second set of data stored in the second session data storage zone in the same manner as the first set of data stored in the first session data storage zone, including not erasing the second set of data when the computer is restarted.

18. The method as set forth in claim 17, further including the steps of
establishing a subsequent session data storage zone for a subsequent set of data;
including in the subsequent set of data an attempted change to a previous session data storage zone by writing the attempted change to and reading the attempted change from the subsequent session data storage zone;
creating a map associating the subsequent set of data with the previous set of data;
allowing a user to reject the subsequent set of data by substantially automatically initializing the map when the computer is restarted; and
allowing the user to accept the subsequent set of data, and, in response thereto, treating the subsequent set of data stored in the subsequent session data storage zone in the same manner as the previous set of data stored in the previous session data storage zone, including not erasing the subsequent set of data when the computer is restarted.

19. The method as set forth in claim 17, further including the step of allowing the user to revert to an earlier set of data by initializing the map associating earlier set of data with a corresponding subsequent set of data.

20. The method as set forth in claim 17, further including the steps of
receiving an identifier from a user;
allowing a user to access one or more of the first, second, or subsequent sets of data based upon the identifier; and
hiding from the user any of the first, second, or subsequent sets of data which are not accessible to the user.

21. A method of handling and storing data in a computer, the method comprising the steps of:
establishing a first session data storage zone for a first set of data;
establishing a plurality of subsequent session, data storage zones, wherein each subsequent session data storage zone is for a specific set of data and includes a specific map of the specific set of data, wherein each specific map references either the first set of data or another specific set of data stored in another subsequent session data storage zone;
including in each subsequent set of data an attempted change to a previous set of data stored in a previous session data storage zone by writing the attempted change to and reading the attempted change from the subsequent session data storage zone;
allowing a user to reject the subsequent set of data by substantially automatically initializing the map when the computer is restarted; and
allowing the user to accept the subsequent set of data, and, in response thereto, treating the subsequent set of data stored in the subsequent session data storage zone in the same manner as the previous set of data stored in the previous session data storage zone, including not erasing the subsequent set of data when the computer is restarted.

22. A method of handling and storing data in a computer, the method comprising the steps of:
establishing a first session data storage zone for a first set of data;
establishing a plurality of subsequent session, data storage zones, wherein each subsequent session data storage zone is for a specific set of data and includes a specific map of the specific set of data, wherein each specific map references either the first set of data or another specific set of data stored in another subsequent session data storage zone;
including in each subsequent set of data an attempted change to a previous set of data stored in a previous session data storage zone by writing the attempted change to and reading the attempted change from the subsequent session data storage zone;
allowing a user to reject the subsequent set of data by substantially automatically initializing the map when the computer is restarted;
allowing the user to accept the subsequent set of data, and, in response thereto, treating the subsequent set of data stored in the subsequent session data storage zone in the same manner as the previous set of data stored in the previous session data storage zone, including not erasing the subsequent set of data when the computer is restarted;
allowing the user to revert to an earlier set of data by initializing the map associating earlier set of data with a corresponding subsequent set of data;
receiving an identifier from a user;
allowing a user to access one or more of the first or subsequent sets of data based upon the identifier; and
hiding from the user any of the first or subsequent sets of data which are not accessible to the user.
